(19) United States
(12) Patent Application Publication
(10) Pub. No.: US 2006/0163167 A1
(43) Pub. Date: Jul. 27, 2006

(54) Method of producing active water and apparatus thereof

(75) Inventor: Tomoyuki Godai, Hyogo (JP)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MAYATEC CO., LTD., Kobe-Shi (JP)

(21) Appl. No.: 10/606,173

(22) Filed: Jun. 25, 2003

(51) Int. Cl. C02F 1/32

(52) U.S. Cl. 210/748

(57) ABSTRACT

To provide an active water producing method of inexpensively producing active water in a short time and an apparatus thereof. In the method and the apparatus, purified water 11 that is generated by removing impurities from water is heated by means of a heater 13, while being applied with a voltage.

### BACKGROUND OF THE INVENTION

1. Field of the Invention

The present invention relates to a method and an apparatus of producing active water.

2. Description of the Related Art

Water is indispensable in life. What this water generally means is city water, and clearly distinguished from so-called mineral water commercially produced from spring water, for example. This mineral water is known to be “delicious,” and the reason for this is attributed to properties of the water. More specifically, mineral water contains less impurities, smaller molecular clusters, and lower oxidation-reduction potential. Because of these, mineral water itself hardly deteriorates in quality and does not corrode a pipe when flowing in the pipe. Furthermore, when used for cooking, mineral water can enhances the flavors of the ingredients.

As used herein, “active water” refers to city water or the like that is artificially processed so as to be close to mineral water. Therefore, active water is more value added for applications in a variety of fields than city water, and hence methods and apparatuses of producing active water have been proposed to now.

To now, active water has generally been produced as follows. FIG. 6 is a view schematically showing a method of producing conventional active water.

Referring to the figure, water 1 (e.g. city water) is allowed to pass through an activated carbon layer 2 to remove chlorine and impurities. Then, the water is stored in an insulating tank 3, in which a conductive electrode 4 (e.g. an stainless steel electrode) is located. A high voltage is applied between an inside and an outside of the tank 3 using a high potential generator 5. This treatment is carried out for 8 hr at an environmental temperature of 5° C. to 10° C. (e.g. inside a refrigerator 6) to generate active water 7.

Unfortunately, with such a conventional method, it takes much time to generate active water.

### SUMMARY OF THE INVENTION

An object of the present invention is to provide a method and an apparatus capable of producing active water having a high utilization value in a short time.

(1) In order to achieve the above object, the present inventor found that active water can be obtained in a short time by heating water when the high voltage is applied to the water by means of the high potential generator.

(2) Accordingly, an active water producing method according to the present invention is characterized in that purified water generated from water by removing impurities therefrom is heated while being applied with a high voltage.

With this method, active water can be generated from city water, for example. First of all, city water is allowed to pass through an activated carbon layer, for example, to remove chlorine and impurities included in the city water. Water subjected to such a treatment is defined as “purified water.” Subsequently, such purified water is stored in a predetermined container, and then a voltage is applied to the purified water. This voltage can be 300 V or higher. Furthermore, while being applied with such a voltage, the purified water is heated to generate active water. Here, the active water is the water having an oxidation-reduction potential of 450 mV or lower.

The voltage applied to the purified water is preferably set to 100 V to 50000 V. Application of such a voltage to the purified water can generate active water.

The purified water is preferably heated to not less than 45° C. and not more than 100° C. Heating the purified water to such a temperature can generate active water quickly.

(3) An active water producing apparatus according to the present invention is characterized in that the apparatus comprises: a tank for storing purified water; a high potential generator for applying a voltage between an inside and an outside of the tank; and a heater for heating the purified water in the tank.

In the above constitution, purified water is stored in a tank, and a voltage is applied to an inside and an outside of the tank by means of a high potential generator. This voltage can be set to 100 V higher, and preferably 300 V or higher. Then, the purified water is heated by means of a heater while being applied with such a voltage, thereby generating active water.

The voltage applied to the purified water is preferably set to 100 V to 50000 V. Application of such a voltage to the purified water can generate active water.

The purified water is preferably heated to not less than 45° C. and not more than 100° C. Heating the purified water to such a temperature can generate active water quickly.

The above and further objects and features of the invention will be more fully be apparent from the following detailed description with accompanying drawings.

### BRIEF DESCRIPTION OF THE DRAWINGS

FIG. 1 is a view schematically showing a constitution of an active water producing apparatus according to an embodiment of the present invention;

FIG. 2 is a view schematically showing a structure of a high potential generator according to an embodiment of the present invention;

FIG. 3 is a table listing results of an experiment in which active water is generated by the active water producing method according to the present invention;

FIG. 4 is a graph plotting the results of the experiment in which the active water is generated by the active water producing method according to the present invention;

FIG. 5 is a graph showing results of another experiment in which active water is generated by the active water producing method according to the present invention; and

FIG. 6 is a view schematically explaining a conventional method of producing active water.

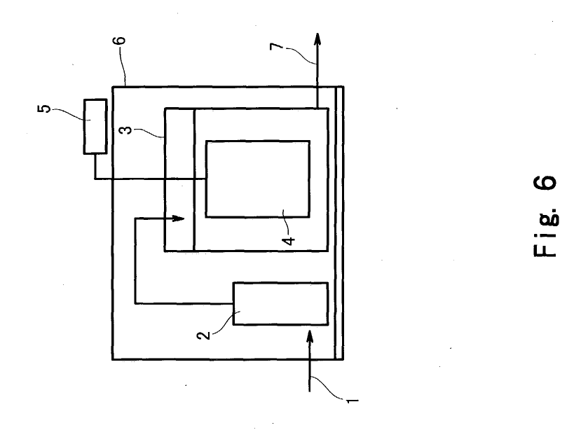

### DETAILED DESCRIPTION OF THE PREFERRED EMBODIMENTS

Hereinbelow, an embodiment of the present invention will be described.

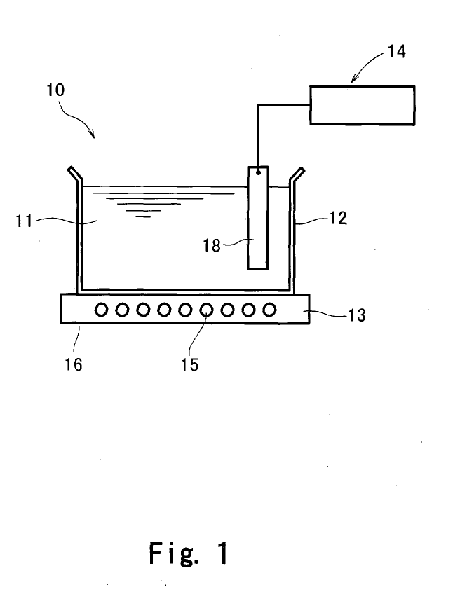

FIG. 1 is a view schematically showing an active water producing apparatus according to an embodiment of the present invention.

Referring to the figure, the active water producing apparatus 10 includes: a tank 12 for storing purified water 11; a heater 13 provided in a bottom portion of the tank 12; and a high potential generator 14 for applying a voltage to purified water 11.

The purified water 11 refers to city water or the like from which chlorine and impurities are removed, and is generated by passing city water through an activated carbon layer, for example. In this case, the activated carbon layer can be comprised of a filter containing activated carbon therein.

The tank 12 can be made of insulating material. Furthermore, the heater 13 can be any kind of heater that heats the purified water 11 in the tank 12. In the present embodiment, an electric heater is used. More specifically, the heater 13 is constituted such that a bar-shaped heating element 15 is provided in a casing 16.

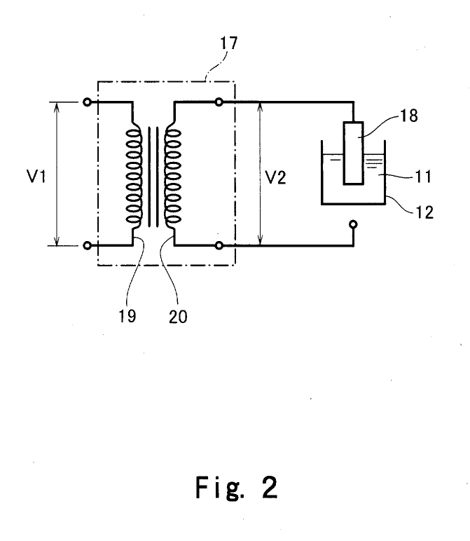

FIG. 2 is a view schematically showing a constitution of a high potential generator.

Referring to the figure, the high potential generator 14 includes a main body 17 and an electrode 18.

The main body 17 has a constitution similar to a so-called transformer, in which application of an input voltage V1 to a low voltage portion 19 can generate an output voltage V2 from a high voltage portion 20. In the present embodiment, the output voltage V2 can vary freely from 300 V to 50000 V. It should be noted that this output voltage V2 can be made to vary from 100 V to 50000 V or higher by changing the internal structure of the main body 17.

As shown in the figure, one end of the high voltage portion 20 is connected to the electrode 18, and the other end is made open. That is, the other end of the high voltage portion 20 is disconnected from the tank 12. As a result, there exists a state in which a kind of condenser is formed between the electrode 18 and the end of the high voltage portion 20 (i.e. between an inside and an outside of the tank), and a voltage V2 is applied therebetween.

As the electrode 18, a planar member made of stainless steel is employed in the present embodiment. However, any other material that is conductive can be used.

With the above-described apparatus, active water can be produced as follows.

First of all, purified water 11 is generated from city water by using activated carbon as described above and stored in a tank 12. Then, the tank 12 is heated by means of a heater 13 to heat the purified water 11. In parallel with this heat treatment, the purified water 11 is applied with a high voltage (300 V or higher) by running a high potential generator 14, thereby turning the purified water 11 into active water. As apparent from experimental result to be discussed later, a voltage applied to the purified water 11 can be 100 V or higher.

In the above case, if the active water produced is used as hot water for serving coffee, the purified water can be heated to 100° C. using the heater 13 or if used for other purposes, the purified water can be heated to a required temperature for each purpose.

When the oxidation-reduction potential of the active water produced by the active water producing apparatus 10 is examined, the oxidation-reduction potential of the active water produced is approximately 250 mV, whereas the oxidation-reduction potential of general city water is 500-600 mV.

As shown in the preceding description, according to the present embodiment, active water can be produced in a short time by carrying out such a simple treatment that purified water is heated while being applied with a high voltage.

Hereinbelow, the results of experiments conducted to study changes in oxidation-reduction potential with change in experimental conditions under which each purified water is heated while being applied with a high voltage will be described.

Experiment 1

In this experiment, 2 liters of city water is heated to a predetermined temperature while being applied with a high voltage. The applied voltage is 10000 V. However, the applied voltage could be set to 100 V to 50000 V.

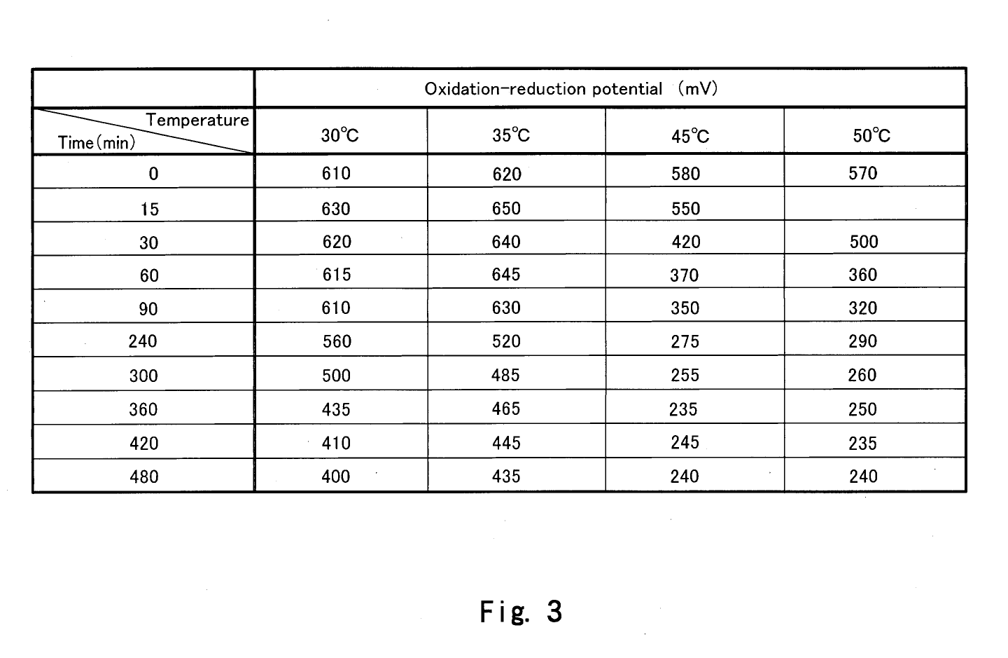

FIG. 3 is a table showing the results of the experiment described above.

As shown in the figure, while being applied with the voltage described above, each city water is heated to a corresponding set temperature of 30° C., 35° C., 45° C., or 50° C. and allowed to stay at the corresponding set temperature for a different period of time as indicated in the figure. From the above experiment, it is found that in order that city water reaches the oxidation-reduction potential of 450 mV or less, it takes approximately 6 hr in the case of the set temperature of 30° C., approximately 7 hr in the case of the set temperature of 35° C., approximately 20 min in the case of the set temperature of 45° C., or approximately 40 min in the case of the set temperature of 50° C.

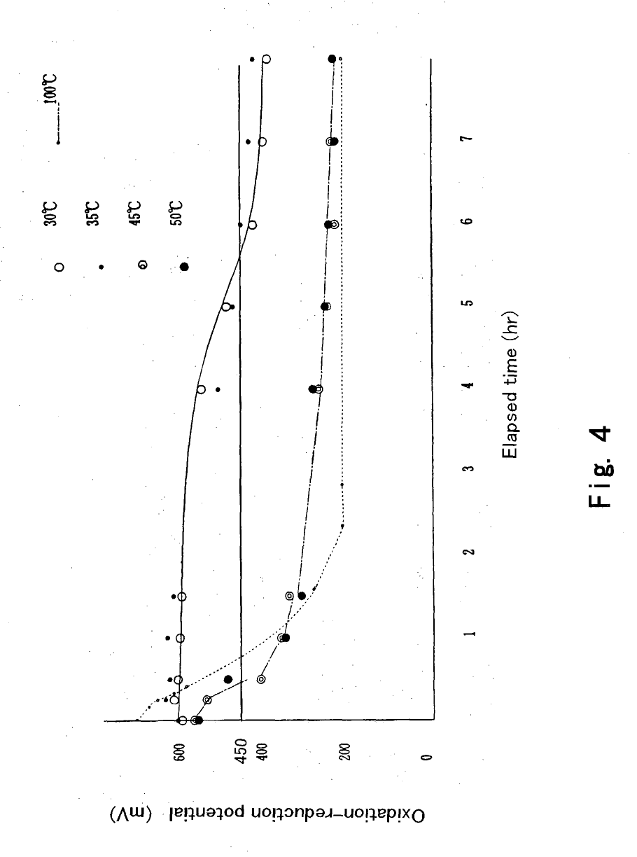

FIG. 4 is a graph plotting the results of each experiment at a different set temperature, with the axis of ordinate being for oxidation-reduction potential and the axis of abscissa being for elapsed time. Small white circles represent the case where the set temperature is 100° C.

As shown in FIGS. 3 and 4, active water can be produced in a fraction of an hour if the set temperature is 45° C. or higher. Furthermore, the oxidation-reduction potential can be kept low.

Experiment 2

this experiment, 2 liters of city water is heated to 100° C. while being applied with a high voltage and thereafter allowed to naturally cool down. The applied voltage is 10000 V. However, the applied voltage could be set to 100 V to 50000 V.

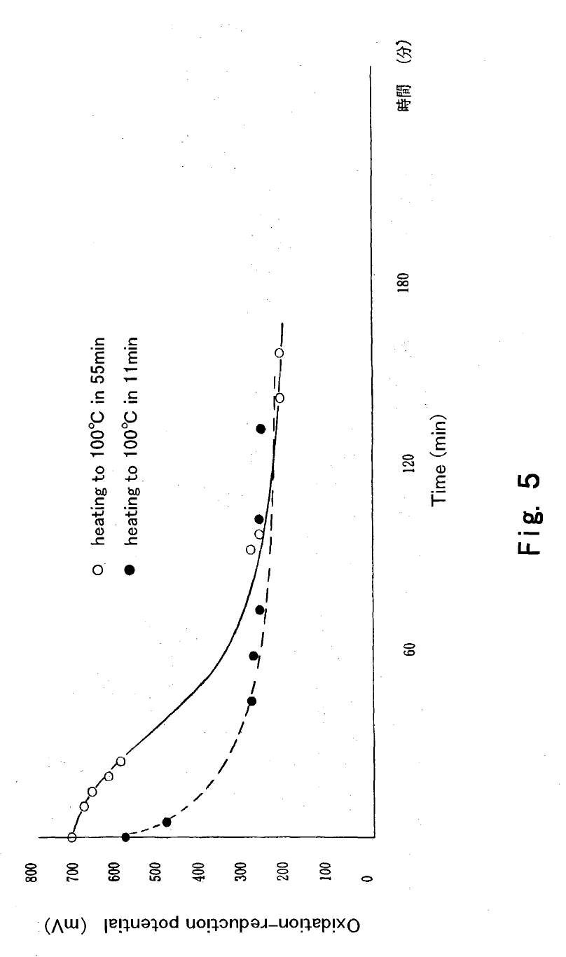

FIG. 5 is a graph showing the results of the experiment described above.

FIG. 5 is a graph showing change in oxidation-reduction potential with change in heating rate at which city water having a temperature of 23° C. is heated to 100° C. and allowed to naturally cool down. Here, white circles represent the case where the city water is heated to 100° C. in 55 min, while black circles represent the case where the city water is heated to 100° C. in 11 min.

As shown in the figure, the high heating rate allows the active water to be produced quicker than the low heating rate.

As shown in the preceding description, according to the present invention, since active water can be produced simply by heating purified water while the purified water is applied with a voltage, active water having a high utilization value can inexpensively be produced in a short time.

Although the present invention has fully been described by way of example with reference to the accompanying drawings, it is to be understood that various changes and modifications will be apparent to those skilled in the art. Therefore, unless otherwise such changes and modifications depart from the scope of the invention, they should be construed as being included therein.

What is claimed is:

1. An active water producing method comprising the step of heating purified water that is generated by removing impurities from water, while applying a high voltage to the purified water.

2. The active water producing method according to claim 1, wherein the voltage applied to the purified water is 100 V to 50000 V.

3. The active water producing method according to claim 1, wherein the purified water is heated to not less than 45° C. and not more than 100° C.

4. The active water producing method according to claim 2, wherein the purified water is heated to not less than 45° C. and not more than 100° C.

5. An active water producing apparatus comprising:
a tank for storing purified water generated by removing impurities from water;
a high potential generator for applying a voltage between an inside and an outside of the tank; and
a heater for heating the purified water in the tank.

6. The active water producing apparatus according to claim 5, wherein the high potential generator outputs a voltage of 100 V to 50000 V.

7. The active water producing apparatus according to claim 5, wherein the heater is set to heat the purified water to not less than 45° C. and not more than 100° C.

8. The active water producing apparatus according to claim 6, wherein the heater is set to heat the purified water to not less than 45° C. and not more than 100° C.
